(19) United States
(12) Patent Application Publication
(10) Pub. No.: US 2013/0167057 A1
(43) Pub. Date: Jun. 27, 2013

(54) DISPLAY APPARATUS FOR RELEASING LOCKED STATE AND METHOD THEREOF

(71) Applicants: Ji-yeon KWAK, Seoul (KR); Jung-joo Sohn, Seoul (KR); Nipun Kumar, Suwon-si (KR)

(72) Inventors: Ji-yeon KWAK, Seoul (KR); Jung-joo Sohn, Seoul (KR); Nipun Kumar, Suwon-si (KR)

(73) Assignee: Samsung Electronics Co., Ltd., Suwon-si (KR)

(21) Appl. No.: 13/590,798

(22) Filed: Aug. 21, 2012

(30) Foreign Application Priority Data
Dec. 23, 2011 (KR) 10-2011-0141802

(51) Int. Cl. G06F 3/048

(52) U.S. Cl. 715/767

(57) ABSTRACT

Methods and apparatus are provided for releasing a locked state of a display apparatus. A display unit displays a locked view having an affordance object. When the affordance object is touched at a touch point, the control unit controls the display unit to switch to an unlocked view while tilting the affordance object in a direction corresponding to the touch point.

### PRIORITY

This application claims priority under 35 U.S.C. §119(a) to Korean Patent Application No. 2011-0141802 filed on Dec. 23, 2011 in the Korean Intellectual Property Office, the entire disclosure of which is incorporated herein by reference.

### BACKGROUND OF THE INVENTION

1. Field of the Invention

The present invention relates generally to a display apparatus, and more particularly, to a display apparatus for releasing a locked state using an affordance object displayed in a locked view, and a method for releasing the locked state.

2. Description of the Related Art

Various display devices have been developed in accordance with the advances in electronic technology. Recent, the use of display devices, such as, for example, smart phones or tablet Personal Computers (PCs), which support various applications is rapidly increasing.

A display device may include a large touch screen, which allows a user to more easily control the manipulation of the display device while viewing contents. However, when using the large touch screen, the screen of the display device may be touched to execute a function even when it is not the user's intention.

To avoid this, the display device can include a locking function. When the screen is touched or a key is selected while in a locked state, no function is performed. The user can release the locked state with a preset manipulation.

The user manipulation for releasing the locked state can be defined by a display device manufacturer. For example, the manufacturer can design to release the locked state only through a predefined manipulation within a fixed part on the screen.

However, when the fixed manipulation is continuously performed in the fixed part of the screen, pixels of the corresponding part or touch sensors under the screen are repeatedly used, thereby degrading the sensing performance.

Further, the fixed or predefined manipulation does not meet user's needs for a more dynamic and interesting User Interface (UI).

### SUMMARY OF THE INVENTION

The present invention has been made to address at least the above problems and/or disadvantages and to provide at least the advantages described below. Accordingly, an aspect of the present invention provides a display apparatus that allows a user to easily and intuitively release a locked state using an affordance object, and a method for releasing the locked state.

According to an aspect of the present invention, a display apparatus is provided that includes a display unit for displaying a locked view having an affordance object. The display apparatus also includes a control unit for, when the affordance object is touched at a touch point, controlling the display unit to switch to an unlocked view while tilting the affordance object in a direction corresponding to the touch point.

The affordance object is tiltable in a plurality of different tilt directions, and a different operation is mapped to each of the plurality of different tilt directions respectively.

When the affordance object is tilted in a first tilt direction mapped to an unlocking operation, the control unit controls the display unit to switch to the unlocked view, and when the affordance object is tilted in a second tilt direction mapped to another operation, the control unit releases a locked state and controls the display unit to display an execution view of a function mapped to the second tilt direction

The control unit recognizes the touch inside one of a plurality of regions of the affordance object, and controls the display unit to tilt the affordance object in a direction corresponding to the one of the plurality of regions.

When an operation mode is changed while the locked view is displayed, the control unit changes an operation mapped to each of the plurality of different tilt directions to a new operation corresponding to the changed operation mode.

The display apparatus may further include a communication unit for receiving a call connection request while the locked view is displayed. When the call connection request is received, the control unit may map a call connection operation to a first tilt direction, and map a call rejection operation to a second tilt direction.

The display apparatus may further include a communication unit for receiving a call connection request. When the call connection request is received, the control unit may display an object tiltable in a plurality of different directions in response to a user touch, in a screen, and control the communication unit to connect the call when the object is tilted in a first direction and to reject the call when the object is tilted in a second direction.

According to another aspect of the present invention, a method is provided for releasing a locked state of a display apparatus. A locked view having an affordance object is displayed. When the affordance object is touched at a touch point, the affordance object is tilted in a direction corresponding to the touch point. The display apparatus is switched to an unlocked view.

The affordance object may be tiltable in a plurality of different tilt directions, and a different operation is mapped to each of the plurality of different tilt directions respectively, and the display apparatus is switched to the unlocked view when the affordance object is tilted in a first tilt direction mapped to an unlocking operation.

The method may further include when the affordance object is tilted in a second tilt direction mapped to another operation, releasing the locked state and displaying an execution view of a function mapped to the second tilt direction.

The affordance object tilting step may recognize the touch in one of a plurality of regions of the affordance object, and tilt the affordance object a direction corresponding to the one of the plurality of regions.

The method may further include when an operation mode is changed while the locked view is displayed, changing the operation mapped to each of the plurality of different tilt directions to a new operation corresponding to the changed operation mode.

The method may further include receiving a call connection request while the locked view is displayed; and mapping a call connection operation to a first tilt direction, and mapping a call rejection operation to a second tilt direction.

The method may further include receiving a call connection request; displaying an object tiltable in a plurality of different directions in response to user touch, in a screen; and connecting the call when the object is tilted in a first direction and rejecting the call when the object is tilted in a second direction.

As set forth above, the user can easily release the lock using the affordance object. Hence, the concentrated use of a particular part of the screen can be prevented and the user's satisfaction can be increased.

### BRIEF DESCRIPTION OF THE DRAWINGS

The above and other aspects, features and advantages of the present invention will be more apparent from the following description when taken in conjunction with the accompanying drawings, in which:

FIG. 1 is a block diagram illustrating a display apparatus, according to an embodiment of the present invention;

FIGS. 2 and 3 are diagrams illustrating various unlocking methods in the display apparatus, according to embodiments of the present invention;

FIG. 4 is a block diagram illustrating a display apparatus, according to another embodiment of the present invention;

FIG. 5 is a diagram illustrating affordance object display change when a call connection request is received, according to an embodiment of the present invention;

FIGS. 6 through 9 are diagrams illustrating various affordance objects, according to embodiments of the present invention;

FIG. 10 is a diagram illustrating functions mapped to tilt directions of the affordance object, according to an embodiment of the present invention;

FIGS. 11 through 15 are diagrams illustrating various user manipulations, according to embodiments of the present invention;

FIG. 16 is a flowchart illustrating an unlocking method, according to an embodiment of the present invention; and

FIG. 17 is a flowchart illustrating an unlocking method, according to another embodiment of the present invention.

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

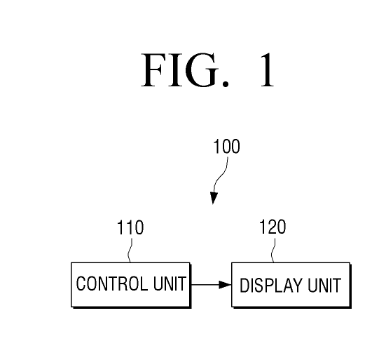

FIG. 1 is a block diagram illustrating a display apparatus according to an embodiment of the present invention. Referring to FIG. 1, a display apparatus 100 includes a control unit 110 and a display unit 120.

The control unit 110 controls operations of the display apparatus 100. The control unit 110 can control hardware of the display apparatus 100 and support various functions by executing an Operating System (O/S) or various applications stored to a memory of the display apparatus 100.

When the display apparatus 100 is turned on or reset, when the ongoing function of the display apparatus 100 is completed, or when there is no user manipulation or no operation of the display apparatus 100 during a certain time, the control unit 110 operates in a locked state. In the locked state, the control unit 110 controls the display unit 120 to display a locked view.

The display unit 120 displays the locked view including an affordance object. The affordance object is an object generated to induce the user manipulation.

When the affordance object is touched, the control unit 110 controls the display unit 120 to switch to an unlocked view while tilting the affordance object in a direction corresponding to the touch point. Specifically, when a right side of the affordance object is touched, the affordance object is tilted in the right direction.

In this case, the tilt degree can differ according to the touch strength or the touch time. For example, when the touch is light or short, the control unit 110 can control the display unit 120 to visually represent that the affordance object is slightly tilted in the touched direction and then returns to its original position. When the touch is strong or long, the tilt speed or angle increases. Hence, when the touch exceeds a threshold, the control unit 110 controls the display unit 120 to rotate the affordance object over 90 degrees and to switch to the unlocked view.

According to embodiments of the present invention, the locked view may display a graphical indicator or a text beside of the affordance object to indicate that the corresponding affordance object can be tilted.

Alternatively, the control unit 110 can display the affordance object periodically waving in the tilt direction in the locked view so as to induce the user's touch.

The affordance object can tilt in a plurality of different tilt directions. The affordance object can tilt in two directions, such as, for example, right and left or upward and downward, in four directions, such as, for example, left, right, up and down, or an even greater number of directions. The tilt direction can be variously determined based on a type of the affordance object.

When the affordance object is tilted in any direction, the control unit 110 can control the display unit 120 to switch to the unlocked view. The unlocked view can be a background view displaying application icons, or an execution view that was previously displayed.

Alternatively, the control unit 110 can map different functions to the tilt directions of the affordance object respectively, and conduct the operation mapped to the tilt direction when the affordance object is tilted, which is described in greater detail below.

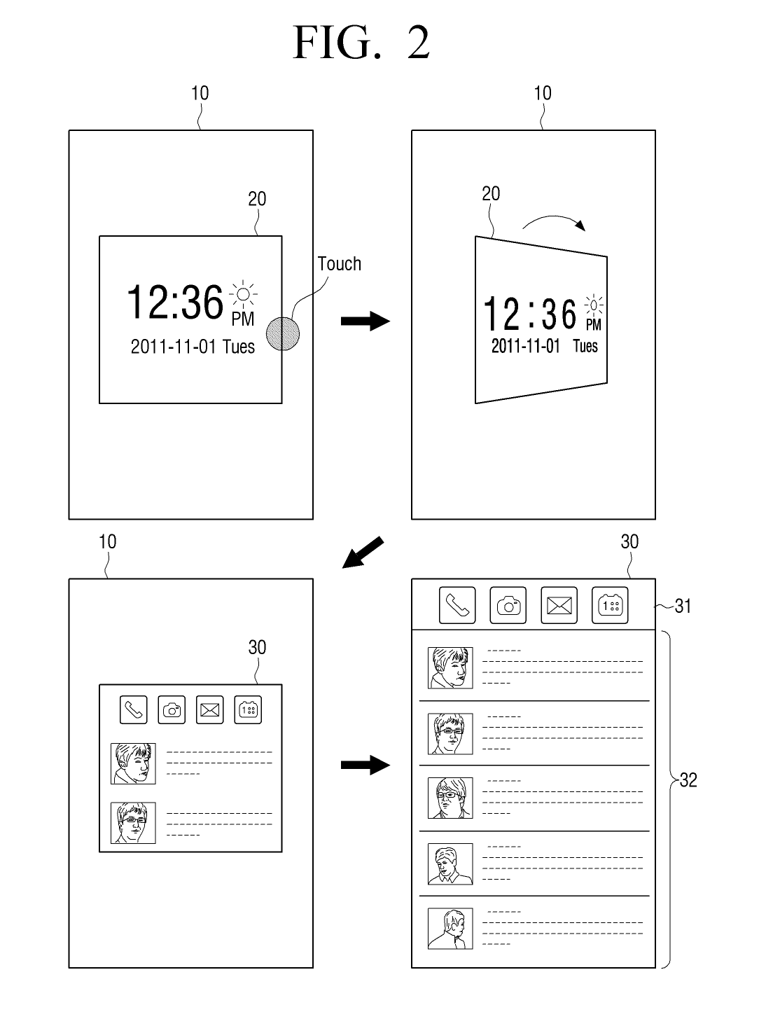

FIG. 2 illustrates an unlocking method by tilting the affordance object, according to an embodiment of the present invention.

Referring to FIG. 2, a locked view 10 includes an affordance object 20. The affordance object 20 may display information such as time, weather and date, and may also display a photo, an image, and a widget window.

A user can touch the affordance object. When the user touches the right side of the affordance object 20 as shown in FIG. 2, the affordance object 20 is tilted to the right and turned over. The rear side of the overturned affordance object 20 includes an unlocked view 30. After the affordance object 20 is completely turned over, the unlocked view 30 can be enlarged and displayed in the full view.

In FIG. 2, the unlocked view 30 includes a fixed menu region 31 for displaying menus steadily, and a particular application execution view region 32. The fixed menu region 31 displays a menu of functions frequently used by the user, such as, for example, call, message, Internet, recent call list, or default functions. The application execution view region 32 displays the execution view of an application used before the display apparatus 100 entered the locked state, a default application, or an application frequently used.

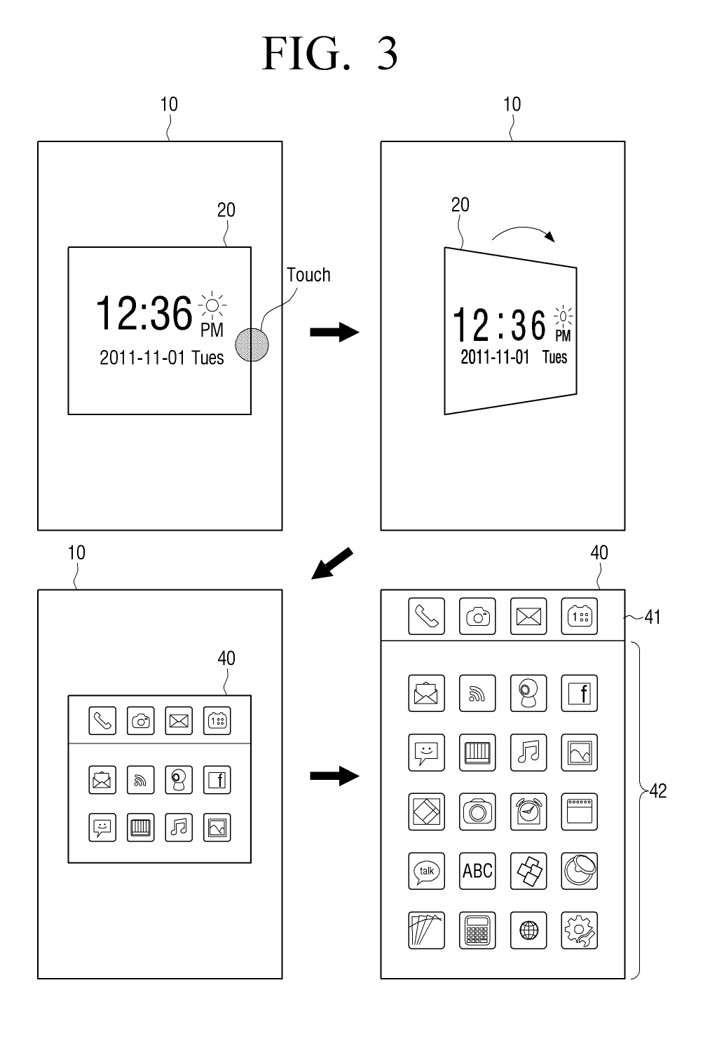

FIG. 3 illustrates another unlocked view, according to an embodiment of the present invention. When the affordance object 20 displayed in the locked view 10 is touched and tilted as shown in FIG. 3, an unlocked view 40 is displayed. The displayed unlocked view 40 can be enlarged to the full view. The unlocked view 40 includes a fixed menu region 41 and an icon region 42 displaying application icons.

While the affordance object 20 is turned over and then the unlocked view displayed on the rear side is enlarged to the full view in FIGS. 2 and 3, the enlargement of the view may be omitted. Alternatively, when the affordance object 20 is turned over, the unlocked view of the full size may be displayed immediately.

While the size of the affordance object 20 is smaller than the full unlocked view 10 in FIGS. 2 and 3, their size may be equalized. Specifically, when the affordance object 20 is turned over, the unlocked view is displayed in the full size without enlarging the unlocked view displayed in the rear side of the affordance object 20.

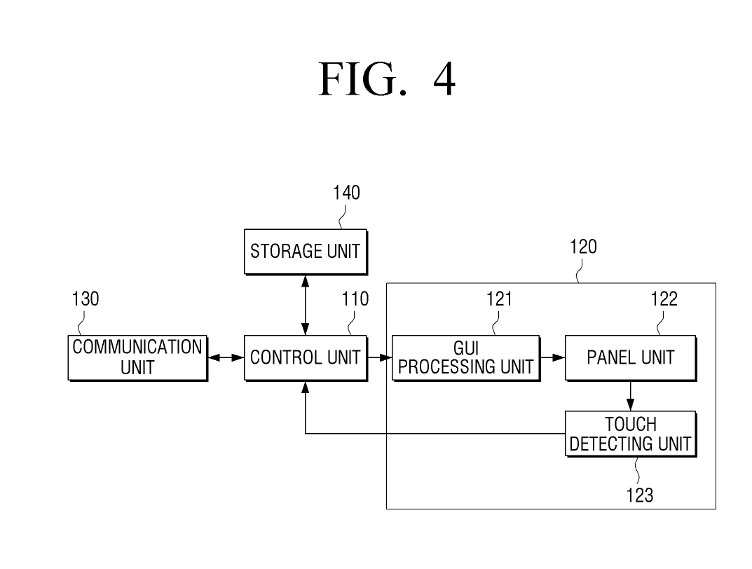

FIG. 4 is a block diagram illustrating a display apparatus, according to another embodiment of the present invention. Referring to FIG. 4, the display apparatus includes the control unit 110, the display unit 120, a communication unit 130, and a storage unit 140.

The display unit 120 includes a Graphical User Interface (GUI) processing unit 121, a panel unit 122, and a touch detection unit 123. Using setup information stored in the storage unit 140, the GUI processing unit 121 generates screen configuration data of various types, such as, for example, a locked view, an unlocked view, and an application execution view. Based on the screen configuration data generated by the GUI processing unit 121, the panel unit 122 displays the view by driving hardware including, for example, a Liquid Crystal Display (LCD) display panel and a backlight unit. The touch detection unit 123 provides coordinates of the user's touch point to the control unit 110 using a touch sensor equipped in the panel unit 122.

The control unit 110 controls the GUI processing unit 121 and the panel unit 122 to output the view corresponding to the current state of the display apparatus. Using the coordinates provided from the touch detection unit 123, the control unit 110 calculates the user's touch point, touch trace, and movement speed. Based on the calculation results, the control unit 110 determines whether to tilt the affordance object.

The storage unit 140 stores, for example, an O/S, applications, a widget program, and data. The control unit 110 can be driven by the O/S stored to the storage unit 140 to execute various applications or widget programs selected by the user, and to carry out the function.

The communication unit 130 receives a call connection request over a telephone network. When the call is connected, the communication unit 130 converts the user's input voice to a voice signal, transmits the voice signal to the other telephone over the telephone network, converts a voice signal received from the other telephone, and provides the voice signal to a speaker (not shown).

In the locked state with the locked view displayed, when the call connection request is received through the communication unit 130, the control unit 110 can modify the functions mapped to the respective directions of the affordance object. For example, provided that both of the right tilt direction and the left tilt direction are mapped to the unlocked function, after the call connection request is received, the right tilt direction can be mapped to a call connection operation and the left tilt direction can be mapped to a call rejection operation.

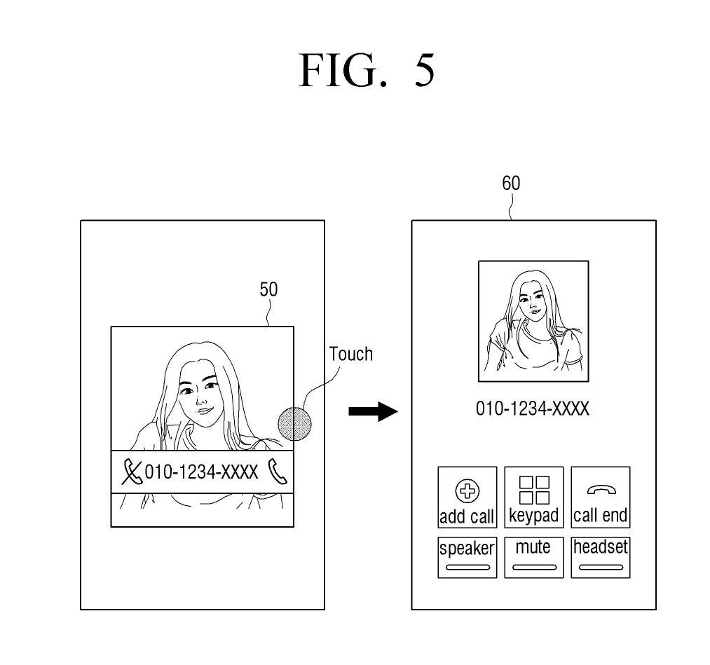

FIG. 5 illustrates the change of the affordance object when the call connection request is received in the locked state, according to an embodiment of the present invention. Referring to FIG. 5, when the call connection request is received, an affordance object 50 displays information such as an image, a name, or a phone number of the caller. A first tilt direction, specifically, the right of the affordance object 50 is mapped to the call connection function, and a second tilt direction, specifically, the left of the affordance object 50 is mapped to the call rejection function. When the user touches the right as shown in FIG. 5, the affordance object 50 is tilted to the right and switched to a call connection view 60. In FIG. 5, the call connection view 60 displays information of the caller and menus selectable during the phone call.

As such, the affordance object can be applied outside of the unlocking method so that the user can easily select various functions.

Meanwhile, the call connection request can be received during non locked state. In this case, the control unit 110 displays the object, which can be tilted in a plurality of different directions in response to the user touch, in the screen. The displayed object can have the same form as the above-stated affordance object, or a separate shape. The tilt directions of the displayed object can be mapped to the call connection function or the call rejection function. The control unit 110 can control the communication unit 130 to connect the call when the object is tilted in the first direction and to reject the call when the object is tilted in the second direction.

There can be various operation modes in addition to the call connection mode, for example, a mode for checking a text message or a mail received, a power-save mode due to the lack of the remaining battery capacity, and a mode for outputting an alarm signal when an alarm set time arrives. In these modes, the control unit 110 can enter various operation modes, such as a mail check mode, a power-saving mode, and an alarm output mode.

Upon entering such an operation mode with the locked view displayed, the control unit 110 changes the operation mapped to the tilt direction of the affordance object to a new operation corresponding to the changed operation mode. For example, when the text message or the mail is received, the function for checking the text message or the mail can be mapped to the right of the affordance object and the function for checking the caller information or postponing the text message or mail check can be mapped to the left. When the alarm set time arrives and the alarm output mode for outputting the alarm signal is performed, the control unit 110 can map an alarm stop function to the right and the left of the affordance object. When entering the power-save mode, the control unit 110 can map a function for returning to the normal mode to the right of the affordance object and a function for maintaining the power-save mode to the left. As such, the function of the affordance object can be variously set according to the situation.

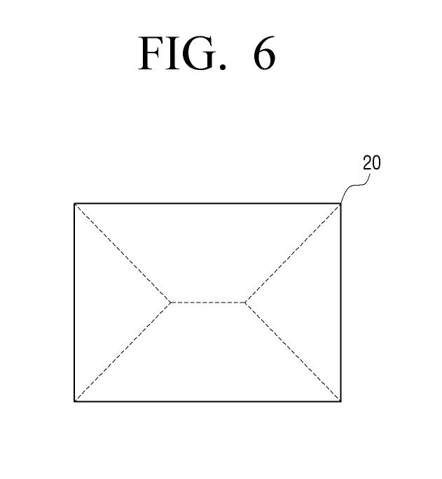

FIGS. 6 through 9 are diagrams illustrating affordance objects, according to embodiments of the present invention.

FIG. 6 illustrates a rectangular affordance object, according to an embodiment of the present invention. The control unit 110 recognizes the touch in the affordance object based on a plurality of regions. In FIG. 6, four regions are divided along dotted lines based on the center of the affordance object. This division is not visually displayed on the affordance object. The control unit 110 controls the display unit 120 to tilt the affordance object in the direction corresponding to the region that includes the touch point among the plurality of the regions.

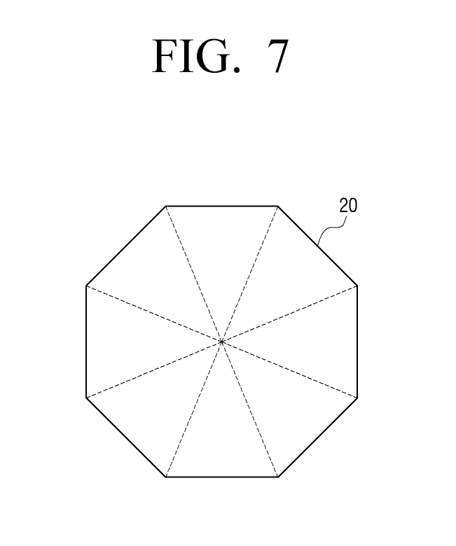

FIG. 7 illustrates an octangular affordance object, according to an embodiment of the present invention. A polygonal object can be tilted in each side direction. Each side direction can be mapped to an individual function.

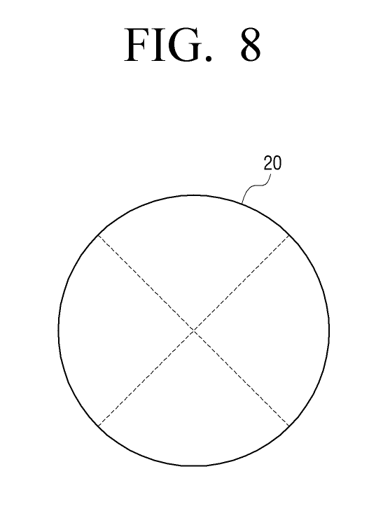

FIG. 8 illustrates a circular affordance object, according to an embodiment of the present invention. The touch can be recognized based on a plurality of regions divided along dotted lines as shown in FIG. 8, and the affordance object can be tilted toward the region that includes the touch point.

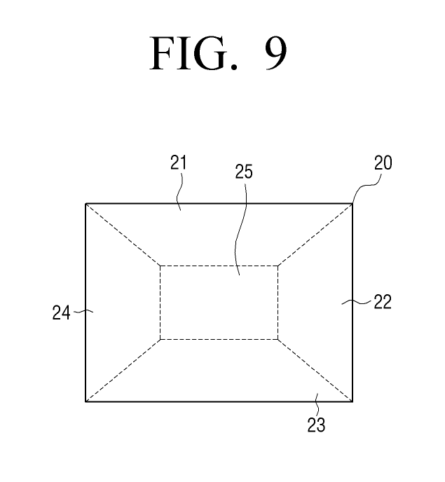

FIG. 9 illustrates a rectangular affordance object divided into five regions to detect the touch, according to an embodiment of the present invention. Referring to FIG. 9, the affordance object includes upper, lower, left, and right regions 21 through 24, and a center region 25. When one of the upper, lower, left, and right regions 21 through 24 is touched, the affordance object is tilted in that direction. When the center region 25 is touched, the visual effect displays that the center region 25 sinks to the bottom and the upper, lower, left, and right regions 21 through 24 are pushed inward, and thus the unlocked view is displayed.

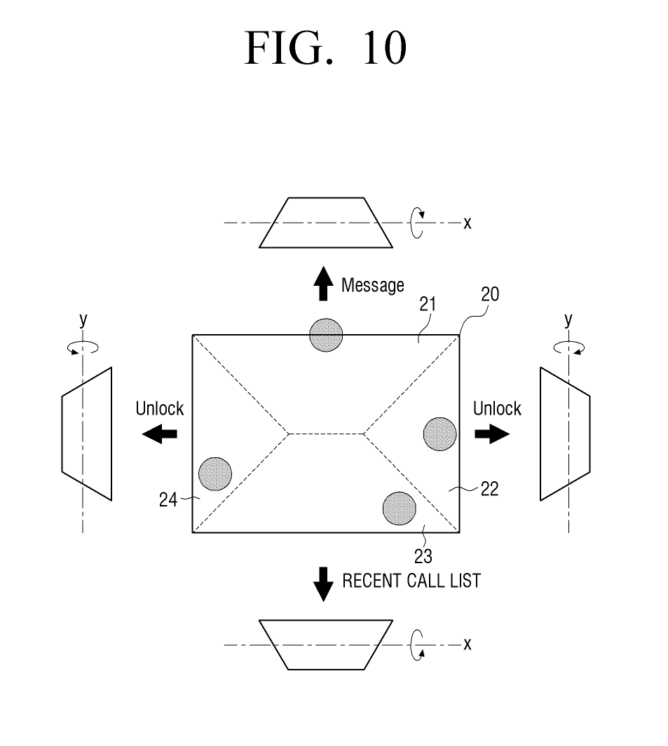

FIG. 10 illustrates functions mapped to the tilt directions of the affordance object, according to an embodiment of the present invention. Referring to FIG. 10, the affordance object 20 is divided into the upper region 21, the right region 22, the lower region 23, and the left region 24, and is tilted toward the touched region. Specifically, when the upper region 21 is touched, the affordance object 20 is titled upwards based on the x-axis. When the right region 22 is touched, the affordance object 20 is titled to the right based on the y-axis. When the left region 24 or the lower region 23 is touched, the affordance object 20 is titled in the corresponding direction.

The upper region 21 is mapped to a message check function, the lower region 23 is mapped to a function for checking the recent call list, and the left and right regions 22 and 24 are mapped to the unlocking function for immediately switching to the unlocked view.

When the upper region 21 is touched, the control unit 110 executes an application for checking the message while releasing the lock and controls the display unit 120 to display the execution view.

When the lower region 23 is touched, the control unit 110 releases the lock and controls the display unit 120 to display the recent call list. As such, depending on the function mapped to each tilt direction of the affordance object, the control unit 110 can switch to the unlocked view or to the individual execution view while releasing the lock at the same time.

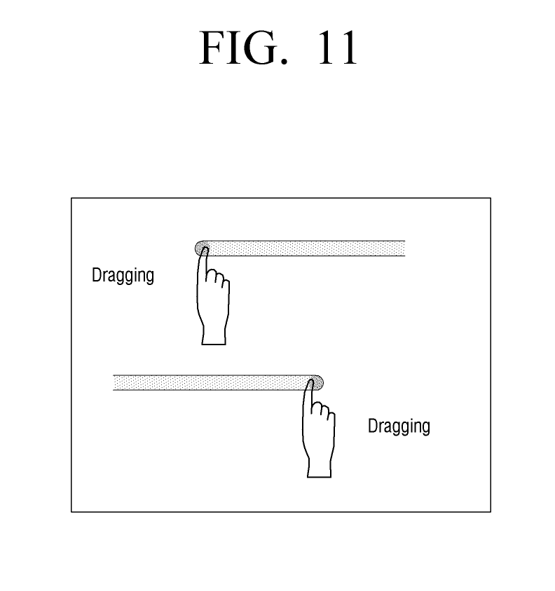

FIGS. 11 through 15 illustrate various user manipulations, according to embodiments of the present invention.

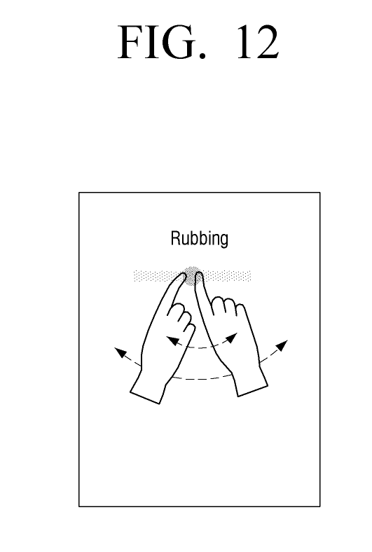

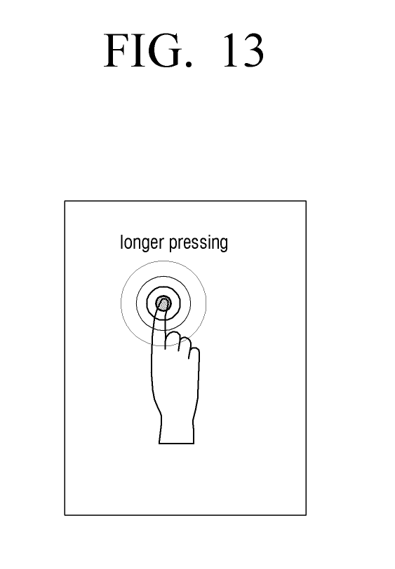

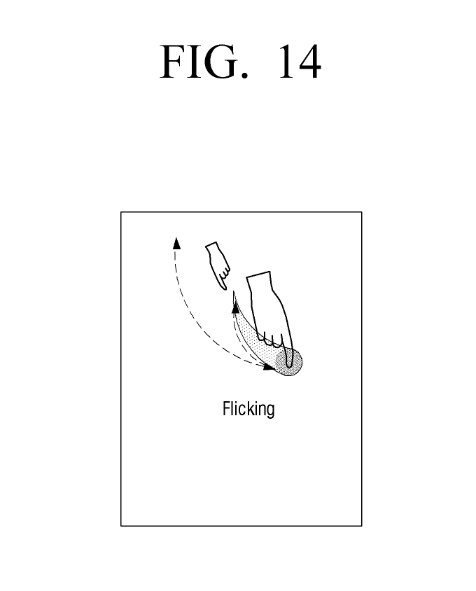

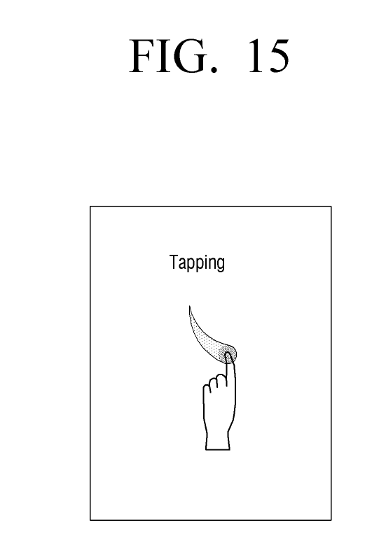

FIG. 11 illustrates a user drag operation, according to an embodiment of the present invention. The drag operation is performed by touching a point and moving to another point while still touching the display. FIG. 12 illustrates a user rubbing operation, according to an embodiment of the present invention. The rubbing operation is performed by touching a point and moving forward and backward. FIG. 13 illustrates a long pressing operation which presses a point over a threshold time, according to an embodiment of the present invention. FIG. 14 illustrates a flicking operation which touches a point and suddenly moves in one direction, according to an embodiment of the present invention. FIG. 15 illustrates a tapping operation in which a fingertip softly touches the display, according to an embodiment of the present invention. As such, the user can touch the screen in various manners to tilt the affordance object. Specifically, when the user drags or flicks, the affordance object can be tilted according to the direction. When the user rubs, presses long, or taps the affordance object, the affordance object can be tilted according to the position that is touched.

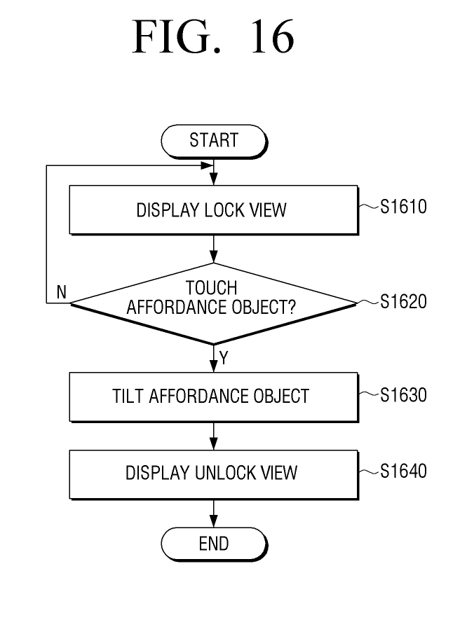

FIG. 16 is a flowchart illustrating an unlocking method, according to an embodiment of the present invention. Referring to FIG. 16, the display apparatus displays the locked view including the affordance object in the locked state, in step S1610. The affordance object is a graphical object that can be tilted in response to the user's manipulation, and can be formed variously as described above.

In step S1620 it is determined whether the user touches the affordance object on the screen using a finger or a touch pen, for example. In response to the touch, the affordance object is tilted in a direction of the touch in step S1630, and the unlocked view is displayed in step S1640. The unlocked view can be displayed as if it is on the rear side of the affordance object, which is completely tilted and turned over. When the size of the affordance object is smaller than the full screen, the unlocked view may be enlarged after the affordance object is turned over. Alternatively, when the affordance object is tilted over certain degrees, the view may be immediately changed to the unlocked view. The unlocked view may be the background view including the plurality of the application icons arranged, or the execution view of the particular application or widget.

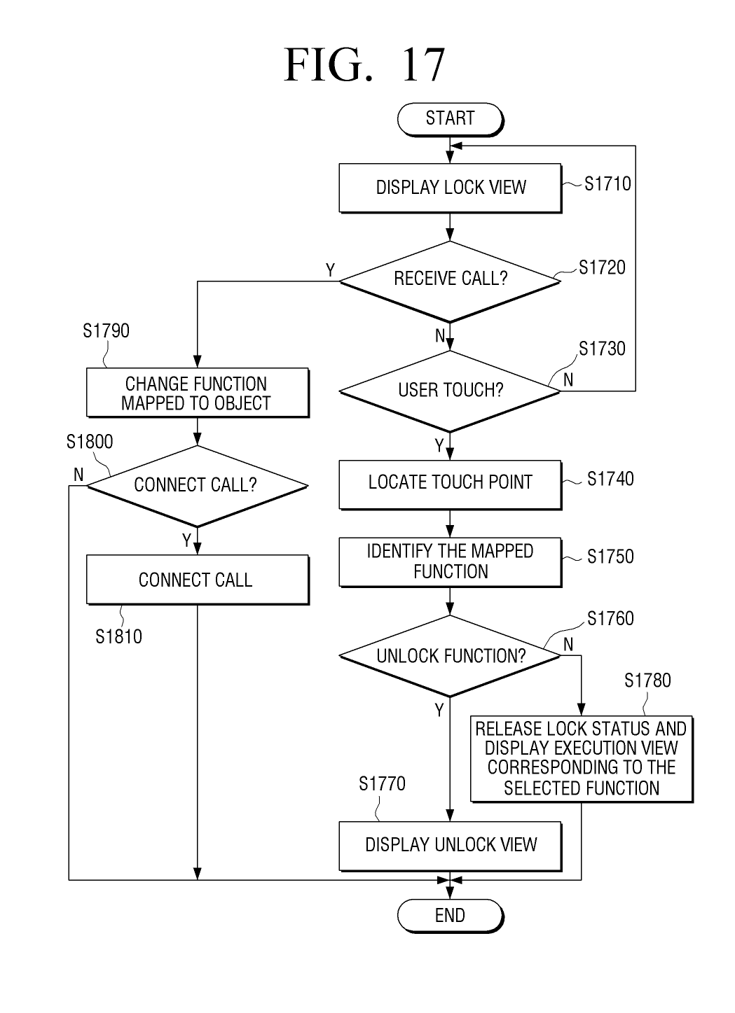

FIG. 17 is a flowchart illustrating an unlocking method, according to another embodiment of the present invention. Referring to FIG. 17, when the locked view is displayed in step S1710, it is determined whether a call is received in step S1720. When the call is received, the display apparatus changes the shape of the affordance object displayed in the locked view and changes the function mapped to the object, in step S1790. For example, the affordance object 20 mapped to the unlocking function, the message check function, and the recent call list display function on the tilt direction basis of FIG. 10 can be changed to the affordance object 50 mapped to the call connection or rejection function of FIG. 5.

The user determines whether to connect the call by touching the region mapped to the call connection or the region mapped to the call rejection in the changed affordance object 50, in step S1800. When the region mapped to the call connection is touched, the affordance object 50 is tilted to connect the call in step S1810 and the view is switched to the call connection view of FIG. 5. By contrast, when the region mapped to the call rejection is touched, the affordance object 50 is tilted toward the touch point to reject the call.

Meanwhile, when the call is not received and the user touches the affordance object, the display apparatus checks the touch point in step S1740 and determines the function mapped to the touch point in step S1750.

In step S1760, it is determined whether the function mapped to the touch point is an unlocking function. When the unlocking function is mapped to the touch point, the affordance object is tilted in the corresponding direction and the unlocked view is displayed, in step S1770. By contrast, when a function other than the unlocking function is mapped, to the touch point, the display apparatus releases the lock and displays the execution view corresponding to the selected function, in step S1780.

While the functions mapped to the tilt directions of the affordance object are modified when the call is received in FIG. 17, other various operation modes than the call reception mode can be provided. Upon entering such operation modes, the display apparatus can change the functions mapped to the tilt directions of the affordance object to new functions corresponding to the changed operation mode.

When the call is received or the operation mode is changed outside of the locked state, the object tiltable in response to the user touch may be displayed. While the object displayed during non locked state is not illustrated as the affordance object for the clarity, such an object also corresponds to the affordance object for inducing the user's touch. When the object is tilted in response to the user touch, the display apparatus conducts the operation mapped to the tilt direction. For example, when the call is received in the unlocked state and the object is displayed, the aforementioned unlocking method can further connect the call for the object tilt in the first tilt direction and reject the call for the object tilt in the second tilt direction.

While the user touches inside the affordance object and the affordance object is tilted in the direction in the embodiments of the present invention, the touch point is not limited to the inside of the object. Specifically, even when the user touches outside the affordance object in the screen, the affordance object can be tilted in that direction. In this case, the tilt direction is determined based on the center of the affordance object. That is, the entire locked view is divided into a plurality of regions based on the center point. When a point is touched on the full view, the affordance object may be tilted in the direction covering the selected point.

The affordance object displayed in the locked view and the affordance object displayed when the call is received or other operation mode is switched can be realized in the same or different form, according to embodiments of the present invention.

Since the user releases the lock by touching a certain point inside or outside the affordance object, the fixed part is not repeatedly used to release the lock. Thus, partial degradation of the touch panel can be prevented, and the user can find interest in releasing the lock to thus maximize the user satisfaction.

A program for executing the unlocking methods according to various embodiments of the present invention can be separately provided and recorded to a recording medium. An apparatus mounted with the recording medium can fulfill the unlocking methods by executing the corresponding program.

In detail, the program for executing the unlocking methods can be contained in various recording media readable by the terminal, such as Random Access Memory (RAM), flash memory, Read Only Memory (ROM), Erasable Programmable ROM (EPROM), Electronically Erasable and Programmable ROM (EEPROM), register, hard disc, removable disc, memory card, USB memory, and CD-ROM.

Although certain embodiments of the present invention have been shown and described, it will be understood by those skilled in the art that various changes in form and detail may be made therein without departing from the spirit and scope of the invention as defined by the appended claims and their equivalents.

What is claimed is:

1. A display apparatus comprising:
a display unit for displaying a locked view comprising an affordance object; and
a control unit for, when the affordance object is touched at a touch point, controlling the display unit to switch to an unlocked view while tilting the affordance object in a direction corresponding to the touch point.

2. The display apparatus of claim 1, wherein the affordance object is tiltable in a plurality of different tilt directions, and a different operation is mapped to each of the plurality of different tilt directions respectively.

3. The display apparatus of claim 2, wherein, when the affordance object is tilted in a first tilt direction mapped to an unlocking operation, the control unit controls the display unit to switch to the unlocked view, and when the affordance object is tilted in a second tilt direction mapped to another operation, the control unit releases a locked state and controls the display unit to display an execution view of a function mapped to the second tilt direction.

4. The display apparatus of claim 2, wherein the control unit recognizes the touch inside one of a plurality of regions of the affordance object, and controls the display unit to tilt the affordance object in a direction corresponding to the one of the plurality of regions.

5. The display apparatus of claim 2, wherein, when an operation mode is changed while the locked view is displayed, the control unit changes an operation mapped to each of the plurality of different tilt directions to a new operation corresponding to the changed operation mode.

6. The display apparatus of claim 2, further comprising:
a communication unit for receiving a call connection request while the locked view is displayed,
wherein, when the call connection request is received, the control unit maps a call connection operation to a first tilt direction, and maps a call rejection operation to a second tilt direction.

7. The display apparatus of claim 1, further comprising:
a communication unit for receiving a call connection request,
wherein, when the call connection request is received, the control unit displays an object tiltable in a plurality of different directions in response to a user touch, in a screen, and controls the communication unit to connect the call when the object is tilted in a first direction and to reject the call when the object is tilted in a second direction.

8. A method for releasing a locked state of a display apparatus, comprising the steps of:
displaying a locked view comprising an affordance object;
when the affordance object is touched at a touch point, tilting the affordance object in a direction corresponding to the touch point; and
switching to an unlocked view.

9. The method of claim 8, wherein the affordance object is tiltable in a plurality of different tilt directions, and a different operation is mapped to each of the plurality of different tilt directions respectively, and
wherein the display apparatus is switched to the unlocked view when the affordance object is tilted in a first tilt direction mapped to an unlocking operation.

10. The method of claim 9, further comprising:
when the affordance object is tilted in a second tilt direction mapped to another operation, releasing the locked state and displaying an execution view of a function mapped to the second tilt direction.

11. The method of claim 9, wherein the affordance object tilting step recognizes the touch in one of a plurality of regions of the affordance object, and tilts the affordance object in a direction corresponding to the one of the plurality of regions.

12. The method of claim 9, further comprising:
when an operation mode is changed while the locked view is displayed, changing the operation mapped to each of the plurality of different tilt directions to a new operation corresponding to the changed operation mode.

13. The method of claim 9, further comprising:
receiving a call connection request while the locked view is displayed; and
mapping a call connection operation to a first tilt direction, and mapping a call rejection operation to a second tilt direction.

14. The method of claim 8, further comprising:
receiving a call connection request;
displaying an object tiltable in a plurality of different directions in response to a user touch, in a screen; and
connecting the call when the object is tilted in a first direction and rejecting the call when the object is tilted in a second direction.
